(19) United States
(12) Patent Application Publication
(10) Pub. No.: US 2019/0197513 A1
(43) Pub. Date: Jun. 27, 2019

(54) REAL TIME SPLITTING OF PAYMENTS FOR TRAVEL

(71) Applicant: MasterCard International Incorporated, Purchase, NY (US)

(72) Inventors: Rosa Maria Rodriguez, London (GB); Anjum Rahber, London (GB); Shannon Grehan, Hoddesson (GB); Ricardo Carretero, London (GB); Aashna Shroff, London (GB)

(21) Appl. No.: 15/850,857

(22) Filed: Dec. 21, 2017

(51) Int. Cl. G06Q 20/32; G06Q 40/00; G06Q 20/10; G06Q 20/34

(52) U.S. Cl. CPC G06Q 20/3223; G06Q 20/3572; G06Q 20/102; G06Q 40/12

(57) ABSTRACT

An apparatus, medium, and method including receiving transaction details related to a purchase transaction from a first user, the transaction details including at least a purchase amount; receiving a request to split the purchase amount between multiple users, the multiple users including the first user; dividing the purchase amount between the multiple users; and completing the purchase transaction directly with the multiple users in accordance with the purchase amount divided between the multiple users and a payment account device associated with each of the multiple users.

### BACKGROUND

In general, the present disclosure relates to the payment of purchase transactions. More particularly, the present disclosure relates to a method and platform to share purchase transaction expenses amongst multiple people.

In many different scenarios, a group of people such as friends and/or relatives might engage in a shared experience or event. The shared experience or event might include, for example, attending a musical performance, restaurant, or sporting event together; vacationing together; or sharing a hotel room or other rental property. Participation in these and other experiences and events typically costs some money.

Oftentimes, one of the people in a group of friends or relatives may initially make a total payment for the shared experience or event directly to a vendor or merchant for all of the group of friends and, at a later point in time, seek reimbursement from each of the friends in the group. However, in the instance one person initially pays the total bill, they alone initially incur the total costs of the bill as opposed to their “fair” share and also have the burden of collecting reimbursement payments from all of the other people in the group.

### BRIEF DESCRIPTION OF THE DRAWINGS

Features, aspects, and advantages of the present disclosure will become better understood when the following detailed description is read with reference to the accompanying drawings in which like characters represent like parts throughout the drawings, wherein:

FIG. 1 is an illustrative diagram of an overview of some of the entities involved in some aspects of the present disclosure;

FIG. 2 is a flow diagram of a process in an exemplary embodiment of the present disclosure; and

FIG. 3 is a schematic block diagram of an apparatus that may be used to execute some aspects of the present disclosure.

### DETAILED DESCRIPTION

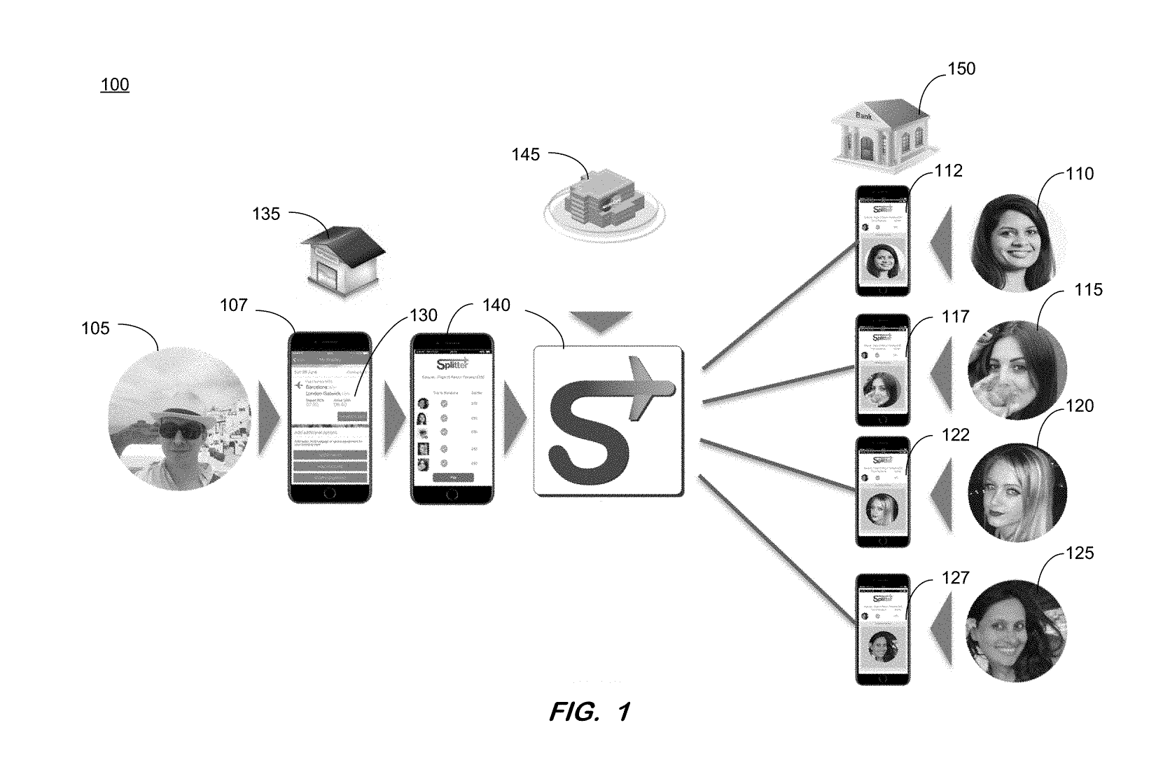

FIG. 1 is an illustrative depiction of some of the entities that may be involved in some aspects and embodiments of the present disclosure. In particular, the entities depicted in the example of FIG. 1 may interact with each other to share expenses amongst a group of people, in accordance with some embodiments herein. In the example of FIG. 1, a group of five friends including persons 105, 110, 115, 120, and 125 will be travelling together on a vacation. The friends will all be travelling by airplane to their final destination. In the present example, the friends would like to be on the same flight to their destination. In an effort to ensure the friends are all booked on the same flight and preferably sitting together, one of the people, friend 105, agrees to book a flight for all of the five friends 105, 110, 115, 120, and 125 in the group that will be travelling together.

In some embodiments herein, friend 105 has a mobile phone and books the airline tickets for the five friends using his mobile phone 107. As seen in FIG. 1, friend 105 accesses an online booking site 130 associated with merchant 135 (e.g., airline) via his phone, either through a browser or an app installed on his phone. Friend 105 progresses through the booking of the flight for the five friends on the merchant's site 130. When the friend 105 is asked to submit a payment for the five airline tickets, friend 105 may, in accordance with the present disclosure, invoke a split transactions payment app (or application) 140 to have the total cost of the five airline tickets divided or split amongst the group of friends 105, 110, 115, 120, and 125.

In some embodiments, app 140 may have been previously installed on friend's 105 phone 107, either by him or his phone's manufacturer or mobile service provider prior to the current purchase transaction. In some instances, app 140 may be installed on phone 107 belonging to friend 105 at the time of the current purchase transaction. Likewise, app 140 may be currently or previously installed on the mobile phones 112, 117, 122, and 127 of the friends 110, 115, 120, and 125, respectively, either by them or their phone's manufacturer or mobile service provider. The split transactions app 140 may be installed on a mobile or other computing device (e.g., laptop computer, desktop computer, tablet, television, and other devices) on and/or on behalf of a split transactions servicer or service provider 145. Split transactions servicer or service provider 145 may be a financial institution or financial products servicer that may support, supply, develop, and/or deploy a split transactions app or service herein.

In some aspects, each person using a split transaction app or service herein may register with the app or service prior to or concurrently with a purchase transaction so that they may each have at least one payment account device (e.g., credit card, debit card, stored value card, gift card, private label account card, rewards card, etc.) of theirs associated with the split transaction app or service. In some embodiments, a split transaction app or service herein may be provided by or on the behalf of a financial institution. In some instances, a user of the split transaction app or service may register a payment account device issued by the financial institution providing the split transaction app or service, although this may not be a requirement or option in some embodiments.

A user of a split transaction app or service herein may register with the split transaction app or service by providing information that sufficiently identifies the user and their payment account information. In some aspects, the information used for registration of the user and one or more of their payment account devices may include a combination of personal information (e.g., name, address, date of birth, and other identifying and biographical information) and financial information (e.g., credit card account, bank account, loyalty program, rewards program, and other payment account device identifying information). In some aspects, the information provided by the users during the registration process may be verified and/or authenticated in accordance with one or more security and anti-fraud regulations, policies, and measures of the financial institutions and servicers associated with a split transaction app and/or the payment account devices being registered with the split transaction app or service.

Referring to FIG. 1 and in response to friend 105 invoking the split transactions payment app 140 to have the total cost of the five airline tickets divided or split amongst the group of friends 105, 110, 115, 120, and 125, friend 105 may select each of the people he wishes to have the total purchase transaction costs divided among. In the example of FIG. 1, friend 105 wishes the have the total cost of the five airline tickets split amongst himself and the other four friends 110, 115, 120, and 125. In some embodiments, friend 105, acting as a “designated purchaser”, may selectively identify one or more other people to share the cost of the purchase transaction with.

In some instances, a designated purchaser may elect to split a purchase transaction among fewer than the total number of people sharing an experience or event. For example, referencing the example of FIG. 1, friend 105 may elect to have the purchase transaction cost split with himself and three of the other friends (e.g., friends 110, 115, and 120) by only selecting three of the friends within split transactions payment app 140. In this instance, friend 105 might be responsible for two “shares” of the total purchase transaction cost (i.e., 2×⅕ of the total cost) and the three friends may each be responsible for their one “share” of the total cost. This example transaction splitting arrangement may be based on, for example, friend 105 agreeing to cover the cost of the airline ticket for friend 125.

In one aspect of the present disclosure, the individuals identified for splitting a purchase transaction (e.g., each of friends 105, 110, 120, and 125 in the primary example of FIG. 1) might each be requested to approve, via split transactions payment app 140 installed and executing on their mobile phone or other device, their portion (i.e., amount) of the split transaction before their associated payment account device registered with the split transactions payment app 140 is used to pay a portion of the total purchase transaction amount. In some embodiments, a user might also be asked or have the option to specify which payment account device to use in the split transaction, if they have more than one registered with the split transactions payment app 140. In some embodiments, each user selected or otherwise identified to participate in a split transaction via split transactions payment app 140 may receive a message or other notification requesting that they affirm their approval for the portion of a total purchase transaction amount to one of their payment account devices prior to a completion of the purchase transaction. The message may be in the form of a text, SMS, email, or other type of message or notification. The users may respond by a similar or other message type.

Upon receipt of a user's affirmation or approval to accept responsibility for the requested split transaction amount, each of the approving users (e.g., 105, 110, 115, 120, and 125) may have one of their payment account devices registered with the split transactions payment app 140 (either explicitly identified for the present purchase transaction or one previously identified by each user) used to settle their portion of the split transaction. In some aspects and embodiments, authorization and settlement of each of the approving users' (e.g., 105, 110, 115, 120, and 125) portion of the split transaction may be processed by financial institution(s) 150 in accordance with processes now known and those that become known in the future.

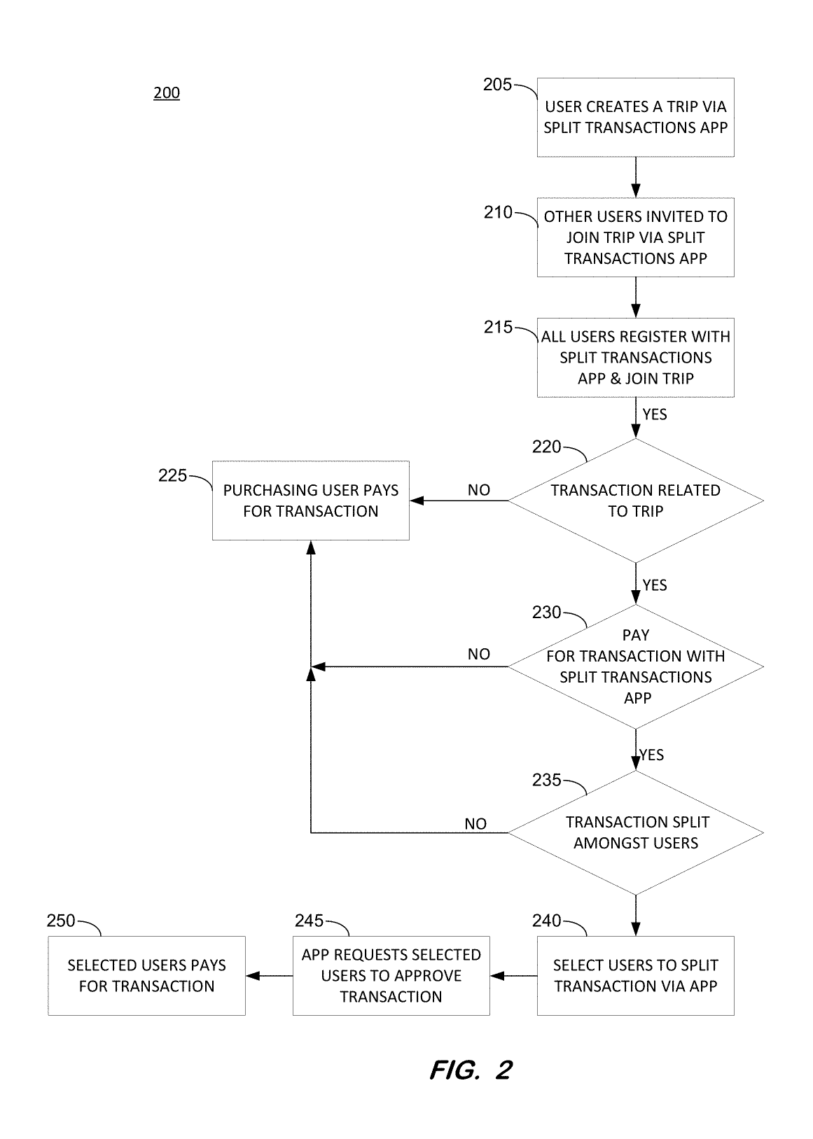

FIG. 2 is an illustrative depiction of a process 200, in some embodiments herein. In some instances, process 200 may relate to splitting a purchase transaction between multiple users (i.e., consumers). In some aspects, process 200 may be implemented, supported, and/or facilitated by a system, platform, or framework such as framework 100 in FIG. 1. Process 200 may be discussed primarily in the context of system 100. However, process 200 is not limited to being executed or implemented on system 100. Some aspects of process 200 may be similar to some of the operations disclosed herein with respect to FIG. 1, accordingly some aspects related to process 200 may be understood based on the discussion of system 100 and might not be repeated.

In some instances, process 200 may be applied to the use-case of a group of people (e.g., friends) travelling as a group on vacation, where the group of people may share a number of experiences and events and wish to split at least some of the purchase transactions incurred during the trip and have the associated costs divided amongst themselves at the time of the purchase transactions. Prior to operation 205, each of the people in the group may have at least one payment account device registered with a split transactions payment app (e.g., FIG. 1, app 140), in accordance with the present disclosure. Accordingly, the individual friends in the group may be referred to as “users”.

At operation 205, one of the user's may create an event within the split transactions payment app. In the present example, the event is the trip the group of users will experience together. It is noted that other experiences, contexts, and use-cases, including those not necessarily related to a trip or travel, may be encompassed within the scope of the present disclosure.

At operation 210, other users in the group are invited to join the event (i.e., the “trip”) by the user that created the trip (i.e., the event creator). The invite to the users may be in the form of a message, notification, or other type of communication. In some embodiments, the invite or request for the users to join the trip may be made from within the split transactions payment app or another app or program (e.g., email) on behalf of the split transactions payment app.

Proceeding to operation 215, all of the people in the group may register with the split transactions payment app 140 (if not previously registered therewith) and further join the trip (or other event). Having joined the trip (i.e., event), all of the users may thereafter participate in future split transactions wherein a total cost of a purchase transaction may be divided between the multiple users at the time of the purchase transaction(s).

At the time of a purchase transaction, a determination is made at operation 220 as to whether the transaction is related to the event(s) associated with users in the split transactions payment app. An indication of whether a purchase transaction is related to a certain event may be determined based on purchase transactions details associated with a purchase, whether generated automatically by a system or device (e.g., a point-of-sale (POS) terminal) or specified by a purchasing user. If the particular purchase transaction is determined not to be related to the event(s) at operation 220, then the purchasing user may be fully responsible for paying for the purchase transaction, as indicated at operation 225.

If the particular purchase transaction is determined to be related to the event(s) at operation 220, then a determination may be made as to whether the purchase transaction will be processed as a split transaction by the split transactions payment app, as indicated at operation 230. If the particular purchase transaction is not to be paid by a split transaction although associated with the event(s), then the purchasing user may be fully responsible for paying for the purchase transaction, as indicated at operation 225.

If the particular purchase transaction is to be paid by a split transaction, then a determination may be made as to whether the purchase transaction will be split amongst multiple users at operation 235. In the event that the particular purchase transaction will not be split amongst the multiple users, then the purchasing user may be fully responsible for paying for the purchase transaction, as indicated at operation 225.

If the particular purchase transaction will be split amongst the multiple users, then process 200 advances from operation 235 to operation 240 where multiple users are selected or otherwise identified for completing the purchase transaction by splitting the transaction by the split transactions payment app.

At operation 245, the split transactions payment app may request the selected users to approve their portion of the split transaction. In response to receipt of the multiple users' approval at operation 245, process 200 may advance to operation 250 where each of the selected users will have their portion of the split transaction paid using their individual payment account devices.

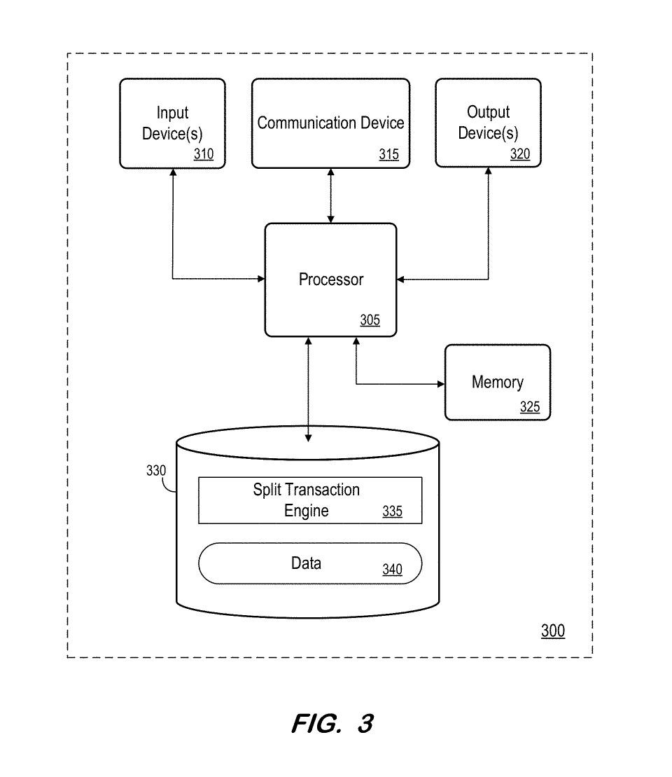

FIG. 3 is an illustrative block diagram of apparatus 300 according to one example of some embodiments. Apparatus 300 may comprise a computing apparatus and may execute program instructions to perform any of the functions described herein. Apparatus 300 may comprise an implementation of server, a dedicated processor-enabled device, a user entity device (e.g., a mobile phone having a split transaction app executing thereon), and other systems, including a cloud server embodiment of at least parts of a split transaction app, application, or service disclosed herein. Apparatus 300 may include other (not shown) elements according to some embodiments.

Apparatus 300 includes processor 305 operatively coupled to communication device 315 to communicate with other systems, data storage device 330, one or more input devices 310 to receive inputs from other systems and entities, one or more output devices 320 and memory 325. Communication device 315 may facilitate communication with other systems and components, such as other external computational assets and data. Input device(s) 310 may comprise, for example, a keyboard, a keypad, a mouse or other pointing device, a microphone, knob or a switch, an infra-red (IR) port, a docking station, and/or a touch screen. Input device(s) 310 may be used, for example, to enter information into apparatus 300 by a user. Output device(s) 320 may comprise, for example, a display (e.g., a display screen) a speaker, and/or a printer.

Data storage device 330 may comprise any appropriate persistent storage device, including combinations of magnetic storage devices (e.g., magnetic tape, hard disk drives and flash memory), solid state storages device, optical storage devices, Read Only Memory (ROM) devices, Random Access Memory (RAM), Storage Class Memory (SCM) or any other fast-access memory. Data storage device 330 might store user-related information including, for example, user preferences, user identifying information (e.g., encrypted identifiers), and other information.

Split transactions engine 335 may comprise program instructions executed by processor 305 to cause apparatus 300 to perform any one or more of the processes described herein, including but not limited to aspects disclosed in FIGS. 1 and 2. Embodiments herein are not limited to execution of these and other processes, either alone in full or part, by a single apparatus, device, or system.

Data 340 (either cached or a full database) may be stored in volatile memory such as memory 325. Data storage device 330 may also store data and other program code for providing additional functionality and/or which are necessary for operation of apparatus 300, such as device drivers, operating system files, etc.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

The above descriptions and illustrations of processes herein should not be considered to imply a fixed order for performing the process steps. Rather, the process steps may be performed in any order that is practicable, including the omission of one or more steps and/or the simultaneous performance of at least some steps.

As used herein and in the appended claims, the term “processor” should be understood to encompass a single processor or two or more processors in communication with each other.

Although the present invention has been described in connection with specific exemplary embodiments, it should be understood that various changes, substitutions, and alterations would be apparent to those skilled in the art and can be made to the disclosed embodiments without departing from the spirit and scope of the invention as set forth in the appended claims.

What is claimed is:

1. A method comprising:
receiving transaction details related to a purchase transaction from a first user, the transaction details including at least a purchase amount;
receiving a request to split the purchase amount between multiple users, the multiple users including the first user;
dividing the purchase amount between the multiple users; and
completing the purchase transaction directly with the multiple users in accordance with the purchase amount divided between the multiple users and a payment account device associated with each of the multiple users.

2. The method of claim 1, wherein the multiple users are each registered for splitting purchase transactions with each other.

3. The method of claim 1, further comprising registering each of the users for splitting purchase transactions with the other multiple users.

4. The method of claim 3, wherein the registering comprises each user authorizing at least one payment account device for use in a split purchase transaction.

5. The method of claim 1, further comprising:
sending, in response to receiving the request to split the purchase amount between the multiple users, a request for approval from each of the multiple users; and
receiving, from each of the multiple users, an approval to participate in the split purchase transaction.

6. The method of claim 1, wherein the purchase transaction is related to a predetermined event.

7. An apparatus comprising:
a processor; and
a memory in communication with the processor, the memory storing executable program instructions, the processor operative with the program instructions to:
receive transaction details related to a purchase transaction from a first user, the transaction details including at least a purchase amount;
receive a request to split the purchase amount between multiple users, the multiple users including the first user;
divide the purchase amount between the multiple users; and
complete the purchase transaction directly with the multiple users in accordance with the purchase amount divided between the multiple users and a payment account device associated with each of the multiple users.

8. The apparatus of claim 7, wherein the multiple users are each registered for splitting purchase transactions with each other.

9. The apparatus of claim 7, wherein the processor is further operative with the program instructions to:
register each of the users for splitting purchase transactions with the other multiple users.

10. The apparatus of claim 9, wherein the registering comprises each user authorizing at least one payment account device for use in a split purchase transaction.

11. The apparatus of claim 7, wherein the processor is further operative with the program instructions to:
send, in response to receiving the request to split the purchase amount between the multiple users, a request for approval from each of the multiple users; and
receive, from each of the multiple users, an approval to participate in the split purchase transaction.

13. The apparatus of claim 7, wherein the purchase transaction is related to a predetermined event.

14. A medium having processor-executable program instructions stored
thereon, the medium comprising:
program instructions to receive transaction details related to a purchase transaction from a first user, the transaction details including at least a purchase amount;
program instructions to receive a request to split the purchase amount between multiple users, the multiple users including the first user;
program instructions to divide the purchase amount between the multiple users; and
program instructions to complete the purchase transaction directly with the multiple users in accordance with the purchase amount divided between the multiple users and a payment account device associated with each of the multiple users.

15. The medium of claim 14, wherein the multiple users are each registered for splitting purchase transactions with each other.

16. The medium of claim 14, further comprising program instructions to register each of the users for splitting purchase transactions with the other multiple users.

17. The medium of claim 16, wherein the registering comprises each user authorizing at least one payment account device for use in a split purchase transaction.

18. The medium of claim 14, further comprising:
program instructions to send, in response to receiving the request to split the purchase amount between the multiple users, a request for approval from each of the multiple users; and
program instructions to receive, from each of the multiple users, an approval to participate in the split purchase transaction.

19. The medium of claim 14, wherein the purchase transaction is related to a predetermined event.
